(19) United States
(12) Patent Application Publication
(10) Pub. No.: US 2002/0078014 A1
(43) Pub. Date: Jun. 20, 2002

(54) Network crawling with lateral link handling

(76) Inventor: David Pallmann, Mission Viejo, CA (US)

Correspondence Address: WILSON SONSINI GOODRICH & ROSATI, 650 PAGE MILL ROAD, PALO ALTO, CA, 943041050

(21) Appl. No.: 09/870,395

(22) Filed: May 30, 2001

Related U.S. Application Data
(60) Provisional application No. 60/208,954, filed on May 31, 2000.

(51) Int. Cl. G06F 7/00

(52) U.S. Cl. 707/1

(57) ABSTRACT

A computer executed method is provided for crawling documents within an Internet domain, the method comprising: (a) having computer executable logic retrieve a document identified by a document address and a crawl depth; (b) having computer executable logic identify any links in the document; (c) having computer system identify which of the identified links in the document are (i) out-of domain links because the identified links do not specify the same Internet domain as the document address, (ii) lateral links to continuation documents of the document by identifying that there are continuation document terms associated with the links, and (iii) standard links to documents lower in the Internet domain's hierarchy by identifying that there are no continuation document terms associated with the links; (d) performing steps (a)-(c) for documents that are identified as being laterally linked to the document of step (a), where the same crawl depth is employed for the laterally linked documents as the crawl depth for the document of step (a); and (e) decreasing the crawl depth by 1 for documents that are identified as being standardly linked to the document of step (a) and performing steps (b)-(d) for the standardly linked documents if the resulting decreased crawl depth is greater than 1.

### RELATIONSHIP TO COPENDING APPLICATIONS

This application is a continuation-in-part of U.S. Provisional Application Ser. No. 60/208,954, filed May 31, 2000, which is incorporated herein by reference in its entirety.

### FIELD OF THE INVENTION

The present invention relates to computer executable logic, systems and methods for crawling documents on the Internet.

### BACKGROUND OF THE INVENTION

In recent years, there has been a tremendous proliferation of computers connected to a global network known as the Internet. A “client” computer connected to the Internet can download digital information from “server” computers connected to the Internet. Client application software executing on a client computer typically accepts commands from a user and obtains data and services by sending requests to server applications running on server computers connected to the Internet.

A number of protocols are used to exchange commands and data between computers connected to the Internet. Examples of these protocols include, but are not limited to the File Transfer Protocol (FTP), the Hypertext Transfer Protocol (HTTP), the Simple Mail Transfer Protocol (SMTP), and the “Gopher” document protocol.

The World Wide Web is an information service on the Internet providing access to documents which may contain information as well as access to other downloadable electronic forms of data and applications. The HTTP protocol is currently used to access data on the World Wide Web, often referred to as “the Web.” It is anticipated that other protocols may be used in the future and are embraced within the scope of this invention.

A Web browser is a client application that communicates with server computers via protocols such as HTTP, FTP, and Gopher protocols. Web browsers receive information from the network and present them to a user.

Each document accessible over the World Wide Web has an unique address which allows an Internet protocol to locate and retrieve the document from a server storing the document. These addresses are commonly referred to as uniform resource locators or URLs. Incorporated into the URL is an Internet domain or web site. Hence, by looking at a document's URL, one is able to determine the Internet domain to which that document is associated.

Each document accessible over the World Wide Web may include text, graphics, audio, or video in various formats. Documents may also include tags. These tags may comprise links or hyperlinks that reference other data or documents which are identified by their URLs. By selecting a link in a document, the document specified by the URL associated with that link may be retrieved.

Links provide a map as to the interrelatedness of documents. By looking at the URLs for different documents, relationships between those documents can be determined. For example, if a link from a first document to a second document is such that URLs for the first and second documents are for the same Internet domain (web site), the link evidences a same domain relatedness between the two documents and is referred to herein as an “in-domain link.” If the link is from a first document to a second document from another Internet domain (web site), it evidences that lesser degree of relatedness and is referred to herein as an “out-of-domain link.”

Any given Internet domain or web site may comprise one or more documents, also commonly referred to as web pages. A web page is a document formatted in one of a number of formats including the Hypertext Markup Language (HTML), Standard Generalized Markup Language (SGML) or extensible Markup Language (XML) that can be displayed by a browser. The links in the documents associated with an Internet domain provide a reader of those documents with both instructions and a mechanism for navigating around the various documents that are associated with that Internet domain or web site.

Use of the Internet and intranets are growing at a dramatic pace. The number of electronic devices such as computers (desktop and laptop), personal data assistants (PDAs), telephones, and pagers being connected to the Internet is growing rapidly. Connectivity to the Internet is now possible using both wired and wireless electronic devices.

The amount of information available over the Internet is also growing rapidly. There is no central authority which controls what information is placed on the Internet. There is also no control with regard to how information placed on the Internet is organized. Thus, the vast amount of information available on the Internet forms a virtual sea of unorganized, unedited information.

In an effort to enhance the availability of information on the Internet, efforts have been made to provide a catalog of the Internet so that files can be quickly located and evaluated to determine if they contain useful information. Because of the vast size of the Internet, specialized types of software, commonly referred to as web crawlers have been developed to crawl through the Internet and collect information about what they find.

Web crawlers are computer programs that automatically retrieve documents associated with one or more Internet domains. A web crawler processes the received data, preparing the data to be subsequently processed by other computer programs. For example, various entities have created web sites that allow one to search the results of a web crawler, these web sites commonly being referred to as search engines or directories. From these search engine or directory web sites, a user can search for documents that include a particular term or select a category of documents. In response, the user is provided with a list of URLs for documents that match the specified criteria. The search engine creates the list by using a web browser software application. For instance, a web crawler may use its retrieved data to create an index of documents available over the Internet. The search engine can later use the index to locate documents that satisfy a specified search criteria.

Web crawlers rely on specialized types of software, such as robots and spiders. Robot programs (“bots” or “agents”) are used to create the databases for search engines and directories. Bots employed for this specific purpose are known as spiders. Spiders crawl Internet domains by visiting a first page and finding subsequent links from that page to other pages. Those pages in turn may link to additional pages. By way of example, features of web crawling for search engine purposes are described in U.S. Pat. No. 5,748,954 Mauldin, which is incorporated herein by reference.

Continued developments in computer science have advanced the capabilities of bots and agents. Many bots now employ crawling for alternate purposes from the original application of building search engine databases. Today, Internet domains are crawled not only by search engine spiders but also by shopping bots, intelligent agents, news gatherers, copyright monitors, download agents, and other automated systems. These systems are employed for reasons beyond the discovery and cataloging of web documents. Often specific content from web documents is sought. For example, an agent may visit a web document to locate an on-line product catalog and extract the part number, description, and price of each listed product. Despite these continued developments, a need still exists for improved web crawlers, a need at least partially addressed by the present invention.

### SUMMARY OF THE INVENTION

A method is provided for identifying continuation documents within an Internet domain, the method comprising: taking a first document address and continuation document terms; having computer executable logic retrieve a first document identified by the first document address; having computer executable logic identify any links to other documents in the first document; and having the computer system identify which of the identified links to the other documents are lateral links to continuation documents of the first document by identifying whether any continuation document terms are associated with the links.

The method may optionally further comprise modifying a crawl depth for a document identified by an identified link which is not a continuation document, the crawl depth not being modified for a document identified by an identified link which is a continuation document.

The method may optionally further comprise having the computer executable logic determine which of the identified links do not specify the same Internet domain as the first document address.

The method may optionally further comprise having the computer executable logic determine which of the identified links have been previously processed.

The method may optionally further comprise modifying a crawl depth for a document identified by an identified link which is not a continuation document, the crawl depth not being modified for a document identified by an identified link which is a continuation document.

The method may also optionally further comprise having computer executable logic determine which of the identified links have been previously processed.

A system is provided for identifying continuation documents within an Internet domain, the system comprising: computer readable logic which takes a first document address and continuation document terms; computer readable logic which retrieves a first document identified by the first document address; computer readable logic which identifies any links to other documents in the first document; and computer readable logic which identifies which of the identified links to the other documents are lateral links to continuation documents of the first document by identifying whether any continuation document terms are associated with the links.

The system may further comprise computer readable logic which modifies a crawl depth for a document identified by an identified link which is not a continuation document, the crawl depth not being modified for a document identified by an identified link which is a continuation document.

The system may further comprise computer readable logic which determines which of the identified links do not specify the same Internet domain as the first document address.

The system may further comprise computer executable logic which determines which of the identified links have been previously processed.

The system may further comprise computer readable logic which modifies a crawl depth for a document identified by an identified link which is not a continuation document, the crawl depth not being modified for a document identified by an identified link which is a continuation document.

The system may further comprise computer readable logic which determines which of the identified links have been previously processed.

A method is also provided for crawling documents within an Internet domain, the method comprising: taking a first document address, a crawl depth and continuation document terms; having computer executable logic retrieve a first document identified by the first document address; having computer executable logic identify any links in the first document; and having computer executable logic identify which of the identified links in the first document are (i) out-of domain links because the identified links do not specify the same Internet domain as the first document address; (ii) lateral links to continuation documents of the first document by identifying that there are continuation document terms associated with the links, and (iii) standard links to documents lower in the Internet domain's hierarchy by identifying that there are no continuation document terms associated with the links.

A method may further comprise having computer executable logic modify the crawl depth associated with documents that are identified as having a standard link to the first document.

A method may further comprise having computer executable logic discard any identified links that have already been analyzed.

A method may further comprise having computer executable logic modify the crawl depth associated with documents that are identified as having a standard link to the first document, the crawl depth associated with documents that are identified as having a lateral link to the first document not being modified.

A system is also provided for crawling documents within an Internet domain, the system comprising: computer readable logic which takes a first document address, a crawl depth and continuation document terms; computer readable logic which retrieves a first document identified by the first document address; computer readable logic which identifies any links in the first document; and computer readable logic which identifies which of the identified links in the first document are (i) out-of domain links because the identified links do not specify the same Internet domain as the first document address; (ii) lateral links to continuation documents of the first document by identifying that there are continuation document terms associated with the links, and (iii) standard links to documents lower in the Internet domain's hierarchy by identifying that there are no continuation document terms associated with the links.

A system may further comprise computer readable logic which modifies the crawl depth associated with documents that are identified as having a standard link to the first document.

A system may further comprise computer readable logic which discards any identified links that have already been analyzed.

A system may further comprise computer readable logic which modifies the crawl depth associated with documents that are identified as having a standard link to the first document, the crawl depth associated with documents that are identified as having a lateral link to the first document not being modified.

A method is also provided for crawling documents within an Internet domain, the method comprising: (a) having computer executable logic retrieve a document identified by a document address and a crawl depth; (b) having computer executable logic identify any links in the document; (c) having computer system identify which of the identified links in the document are (i) out-of domain links because the identified links do not specify the same Internet domain as the document address, (ii) lateral links to continuation documents of the document by identifying that there are continuation document terms associated with the links, and (iii) standard links to documents lower in the Internet domain's hierarchy by identifying that there are no continuation document terms associated with the links; (d) performing steps (a)-(c) for documents that are identified as being laterally linked to the document of step (a), where the same crawl depth is employed for the laterally linked documents as the crawl depth for the document of step (a); and (e) decreasing the crawl depth by 1 for documents that are identified as being standardly linked to the document of step (a) and performing steps (b)-(d) for the standardly linked documents if the resulting decreased crawl depth is greater than 1.

A method may further comprise having computer executable logic discard any identified links that have already been analyzed prior to performing steps (d) and (e).

A system is also provided for crawling documents within an Internet domain, the system comprising: computer readable logic which (a) retrieves a document identified by a document address and a crawl depth; (b) identifies any links in the document; (c) identifies which of the identified links in the document are (i) out-of domain links because the identified links do not specify the same Internet domain as the document address, (ii) lateral links to continuation documents of the document by identifying that there are continuation document terms associated with the links, and (iii) standard links to documents lower in the Internet domain's hierarchy by identifying that there are no continuation document terms associated with the links; (d) performs steps (a)-(c) for documents that are identified as being laterally linked to the document of step (a), where the same crawl depth is employed for the laterally linked documents as the crawl depth for the document of step (a); and (e) decreases the crawl depth by 1 for documents that are identified as being standardly linked to the document of step (a) and performing steps (b)-(d) for the standardly linked documents if the resulting decreased crawl depth is greater than 1.

It is noted that computer readable medium is also provided that is useful in association with a computer which includes a processor and a memory, the computer readable medium encoding logic for performing any of the computer executable methods described herein. Computer systems for performing any of the methods are also provided, such systems including a processor, memory, and computer executable logic that is capable of performing one or more of the computer executable methods described herein.

### BRIEF DESCRIPTION OF THE DRAWINGS

FIG. 1 illustrates a hierarchical structure of documents in a same Internet domain (web site) where documents at a higher level reference documents at a lower level by links incorporated into the documents at the higher level.

FIG. 2 illustrates a hierarchical structure of documents in a same Internet domain (web site) where documents at a higher level reference documents at a lower level by links incorporated into the documents at the higher level, this Internet domain further including continuation documents within a same level in the hierarchy which link to each other.

FIG. 3 illustrates a generalized logic flow diagram for crawling a web site which may have continuation pages.

FIG. 4 provides an embodiment of software in C++ language incorporating the logic flow illustrated in FIG. 3 which may be used in the present invention.

FIG. 5A illustrates a logic flow diagram for crawling a document to identify links that may be present in the document.

FIG. 5B illustrates a logic flow diagram for analyzing links contained in a document in order to determine whether the link is a standard link to another document (either an in-domain link to a lower level of the web site hierarchy or an out-of-domain link to a document not in the web site hierarchy) or a lateral link to a continuation document.

### DETAILED DESCRIPTION

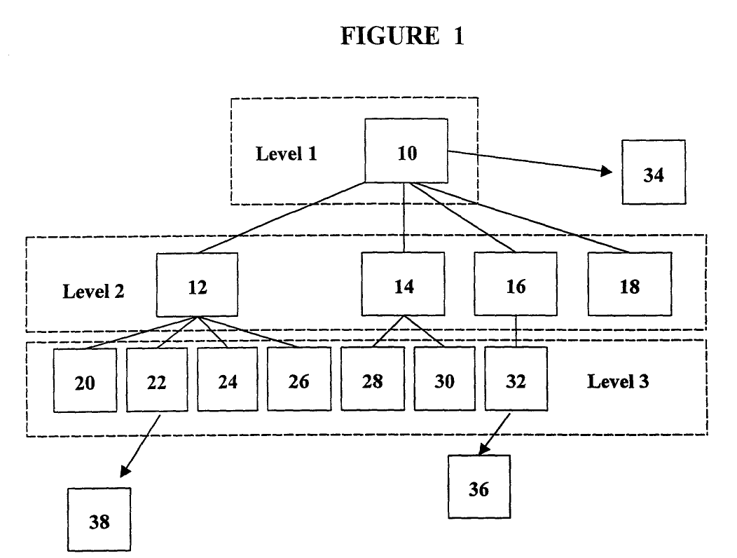

An Internet domain (web site) may be represented as a series of documents arranged in a hierarchical structure. FIG. 1 illustrates a hierarchical structure of documents in a same Internet domain where documents at a higher level reference documents at a lower level by links incorporated into the documents at the higher level. As illustrated, the web site contains a document 12 at the first or highest level of the hierarchy. This document is commonly referred to as the home page or root document. The root document include links to additional documents 14, 16, 18 which are considered to be at a second, lower level of the hierarchy. Each document at the second level may link to 0, 1, 2, 3 or more documents, these linked documents representing the next and in this case the third level of the hierarchy. Documents 20, 22, 24, 26, 28, 30, 32 are shown as documents at the third level. As can be readily seen, the web site hierarchy can extend for however many levels as the person designing the web site may so desire.

Documents 12-32 are considered to be in-domain documents because the links are in-domain links, that is, the link is to another document in the same Internet domain. FIG. 1 also shows several documents 34, 36, 38 which are out-of-domain documents because these documents are not in the same Internet domain as the referencing document. It is noted that whether a given link is an in-domain link or an out-of-domain link can be readily determined by analyzing the Internet domain specified in the URL for each document. If the referenced document does not have the same Internet domain specified in the URL, the link is an out-of-domain link.

As can be seen from FIG. 1, the hierarchical structure of a web site can be quite complex. While this structure is known by the designer of the web site, it is not apparent from any given page and thus is not communicated to spiders which crawl the web site to find other documents in the web site. Instead, software functionality has been developed to streamline the efficiency of crawling a web site by deducing information about the web site's hierarchical structure.

For example, a domain-limiting function has been developed to limit crawling to in-domain documents. Domain-limiting prevents links to a given web document from being followed during the crawling process unless the link is an in-domain link, i.e., the document referenced has the same Internet domain as the referencing document. Given the volume of information that a spider needs to search on the Internet, it is important to be able to limit crawling to a given Internet domain. Otherwise, if a spider blindly followed links to other Internet domains while attempting to crawl a particular web site, the spider could end up crawling the entire Internet rather than the targeted Internet domain and never finish running.

A redundancy checking function has also been developed to help spiders avoid having to crawl already crawled documents. Generally, redundancy checking involves maintaining a list of URLs already visited. When a link to another web document is encountered, the URL is first checked against the list of URLs already visited. If the link specifies a URL on the list, it is deemed redundant and discarded. This is used to prevent the same document from being visited multiple times.

A crawl depth control function has also been developed to help control how many levels into the hierarchy the spider crawls. As noted above, documents are arranged in a hierarchical structure by the person designing the web site where documents that are referenced by a given document are considered lower in the hierarchy than the referencing document. The notion of crawl depth refers to the number of levels into the hierarchical structure of the Internet domain that the web crawler crawls from an initial page.

Limiting the crawl depth helps to control the amount of time and computational resources used to crawl a given Internet domain and can be used to prevent the unnecessary crawling of documents at lower levels in the hierarchy than is desired. For example, if it the task at hand is collecting product pricing and product pricing is known to reside at level 2 in an Internet domain's hierarchy, it is unnecessary and a wasteful use of resources to crawl the site beyond two levels of depth. Some spiders crawl to an infinite depth, such as search engine spiders whose task is to catalog all pages of a web site.

The present invention addresses the further problem of crawling Internet domains whose hierarchy of documents comprises continuation documents. Some documents contain too much information to be displayed on a single screen. In order to enhance the user ergonomics of the web site, web designers sometimes divide a document into multiple documents so that less scrolling is needed to see all of the information on a given document when it is displayed. When a document is divided into multiple document, all of the multiple documents are considered for crawling purposes to belong to the same level in the web site hierarchy. The first document of the multiple documents is typically the document that is referenced by a document at a higher level in the hierarchy. The other documents are considered continuation documents of the prior linking document.

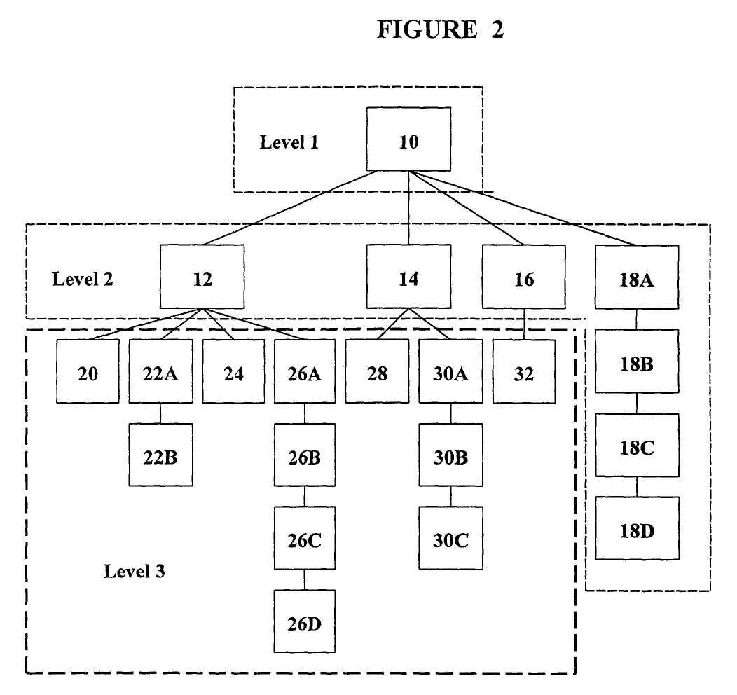

FIG. 2 illustrates a hierarchical structure of documents in a same Internet domain where documents at a higher level reference documents at a lower level by links incorporated into the documents at the higher level, this Internet domain further including continuation documents within a same level in the hierarchy which link to each other. For simplicity, the concept of continuation document is illustrated using the same web site hierarchy as shown in FIG. 1, except that documents 18, 22, 26, and 30 are shown to have continuation documents, as denoted by the element labels “A”, “B”, and “C”.

Since the hierarchy of a web site is not known to the spider, the spider must deduce the hierarchy from the linked documents. As noted above, the spider may include crawl depth limiting functionality which limits its crawl depth. However, if the spider does not know how to identify continuation documents, the continuation documents will be interpreted as a lower depth level. For example, if the spider has a crawl depth set at level 3, documents 18C, 18D, 22B, 26B, 26C, 26D, 30B and 30C will not be crawled because the spider will consider those documents to be at crawl depths greater than 3. If document 10 were to have three continuation pages, a spider whose crawl depth is set at level 3 might not crawl beyond the second continuation document of 10 (e.g., 10A→10B→10C).

The present addresses this problem in the art by providing software and a method for detecting and crawling continuation documents in conjunction with crawling a web site. With the assistance of the present invention, existing spider programs can be improved to distinguish between a link to a lower level of a web site, referred to herein as a standard link, and a link to a continuation document that is at the same level of the web site, referred to herein as a lateral link. As a result, a spider program assisted with the present invention is able to better fulfill its crawling mission more effectively.

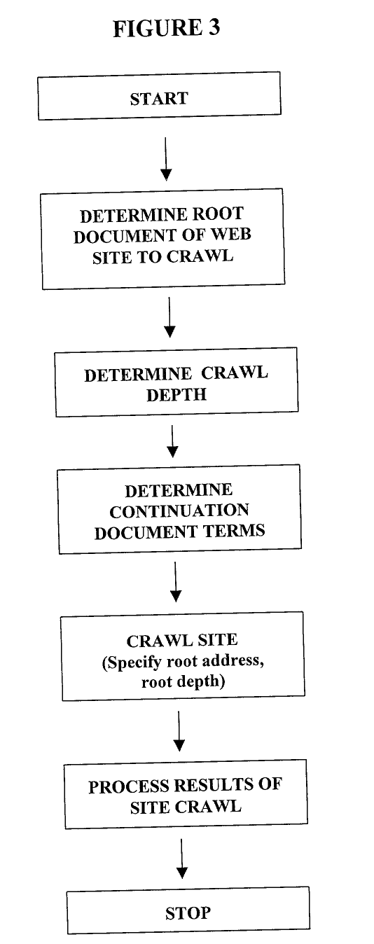

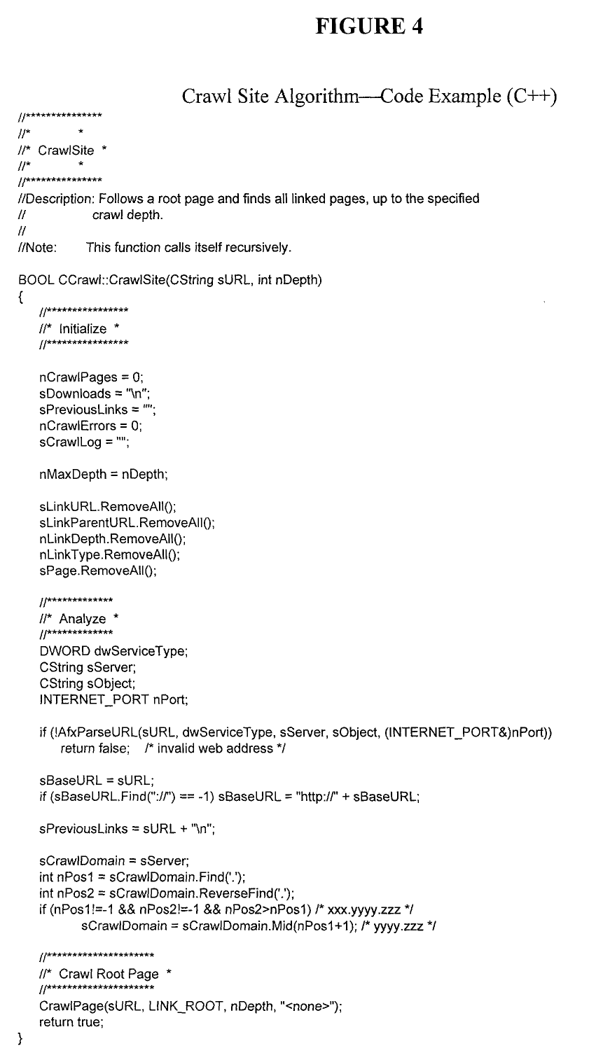

FIG. 3 illustrates a generalized logic flow diagram for crawling a web site which may have continuation pages. FIG. 4 provides an embodiment of software in C++ language incorporating the logic flow illustrated in FIG. 3 which may be used in the present invention.

As illustrated, a web site which is to be crawled is identified. The identification of the web site to be crawled may be done manually, i.e., a user specifying to the program what web site to crawl. Alternatively, an algorithm (not shown) may be used to independently identify web sites to crawl.

Once a web site to crawl is identified, a crawl depth is specified. The crawl depth may be specified manually, i.e., a user specifying to the program a crawl depth for the particular web site. Alternatively, a user may specify a default crawl depth for crawling multiple web sites. An algorithm (not shown) may also be used to analyze the web site in order to determine an appropriate crawl depth.

The web site is also analyzed in order to determine what text description or images are used in order to identify that a given link is a lateral link to a continuation document. Because web sites are designed by multiple different people, most if not all of whom are not involved with the person designing or operating a spider, the spider can not know what language or images a particular web site may use to identify a particular link as a continuation document. It is thus necessary to determine the terms used by a given web site to identify continuation documents.

The identification of terms used by a web site to indicate a link is a lateral link to a continuation document may be performed manually, i.e., a user reviews the web site and writes down the terms used by the web site to indicate a link is a lateral link to a continuation document. Alternately, an algorithm (not shown) may be used to analyze the web site in order to determine terms used by the web site to indicate a link is a lateral link to a continuation document. Optionally, a glossary of terms commonly used to identify a link as a lateral link to a continuation document may be employed. Examples of terms that are commonly used to identify a link as a lateral link to a continuation document include “next page”, “more”, “next matches”, “more results”, and “more products”.

Once a root document for a web site, crawl depth, and continuation document terms are identified, the web site may be crawled. It is noted that the root document address, crawl depth, and continuation document terms can be identified in varying orders, at different times, or at the same time. It is further noted that an aspect of the invention relates to crawling a web site using the combination of a root document address, crawl depth, and continuation document terms where how these items are identified is immaterial to the execution of the crawling.

Once the site has been crawled, the results of the site crawl are processed so that selected documents of the web site, identified via the site crawl, can be further analyzed.

It is noted that the illustrated step of crawling the site is performed using computer executable logic. Meanwhile, the prior steps may be performed manually and/or with the assistance of computer executable logic. It should be understood that once the prior steps are performed so that the root document address, crawl depth, and continuation document terms are identified, the illustrated step of crawling the site may be performed multiple times without having to perform those prior steps again.

1. Crawling Web Site

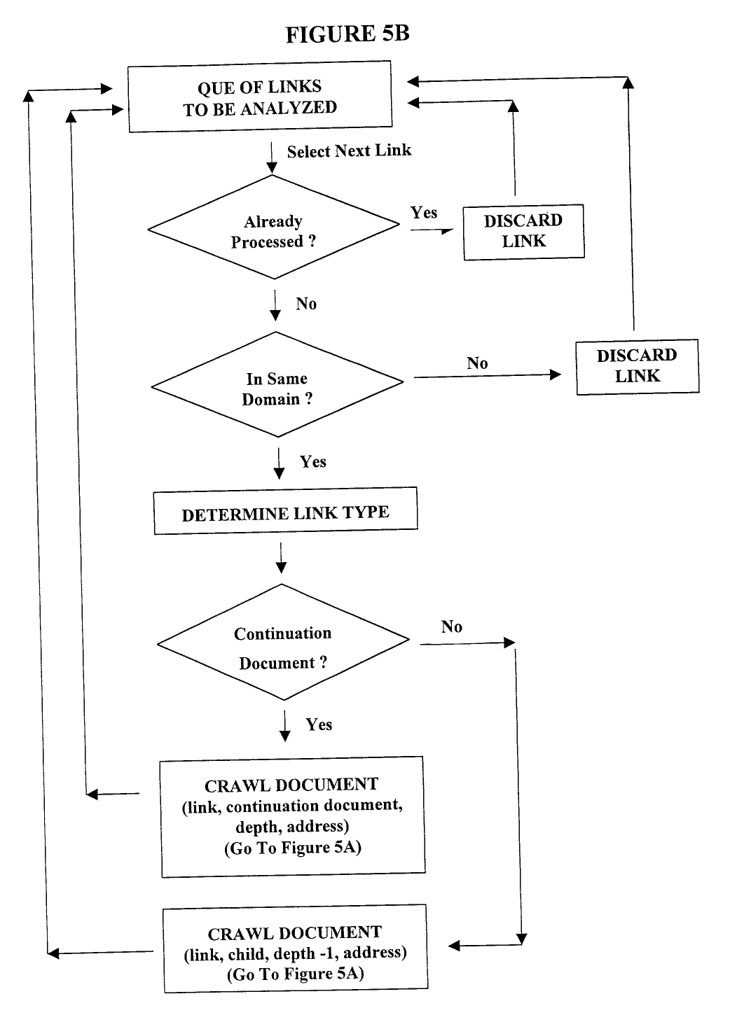

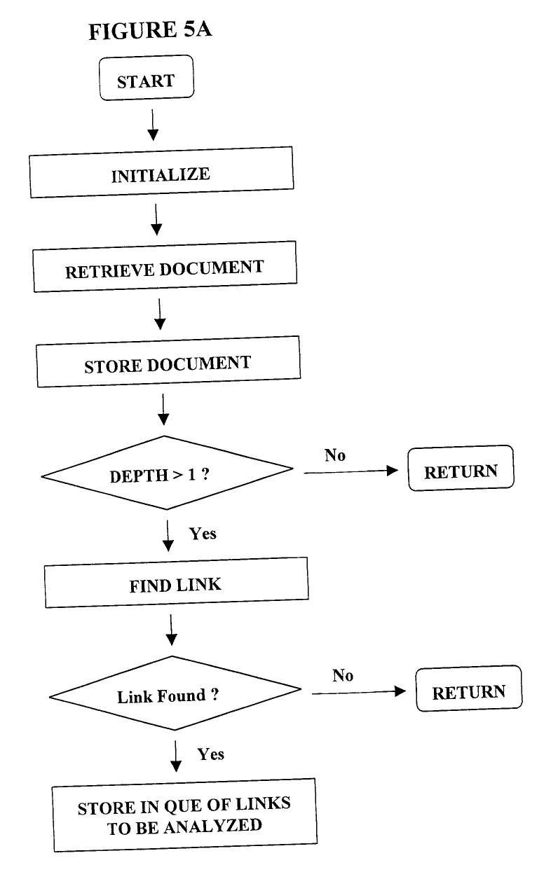

FIG. 5A illustrates a logic flow diagram for crawling a document to identify links that may be present in the document. FIG. 5B meanwhile illustrates a logic flow diagram for analyzing links contained in a document in order to determine whether the link is a standard link to another document (either an in-domain link to a lower level of the web site hierarchy or an out-of-domain link to a document not in the web site hierarchy) or a lateral link to a continuation document.

As illustrated in FIG. 5A, the first step is to initialize storage variables. Examples of storage variables that are initialized include: defining the root document's URL; specifying the crawl depth; specifying the continuation document terms, and setting the number of documents found may be set to zero.

The algorithm is supplied with a root document's URL in order to identify the desired web document that is the starting point of the site crawl. The algorithm is also supplied with a crawl depth in order to identify the desired degree of site crawling that is to be performed. The algorithm is supplied with a list of continuation document terms in order to be able to identify lateral links during the site crawling process. The number of documents is initialized to zero because no documents have yet been retrieved; as the site crawling process proceeds, this value will be incremented as new web documents are encountered.

Once the program has been initialized, the root document is retrieved. It is noted that the example of code provided for retrieving a web document are language and platform dependent. A TCP/IP (Internet) socket connection is made to a server, typically using the Hyper Text Transfer Protocol (HTTP). The web address or URL contains both a logical name for the web server as well as the name of the requested content from the web server. The server responds with the requested content, most commonly a Hyper Text Markup Language (HTML) document (a web page).

The retrieved root document is then stored. This entails recording information about the document such as the document's content, URL, root document's URL, type of document, and the level of the document in the web site hierarchy.

The current depth is then checked. A depth counter is maintained which is initially set during the initialize step. As will be explained, that depth counter is reduced as documents are retrieved and analyzed. When the current depth reaches 1, the process stops, thereby controlling how deep the web site is searched relative to the root document.

As illustrated, if the depth counter is greater than 1, the crawling of the web site continues. The stored document is analyzed to identify any links present in the document. The following are examples of links that may be identified:

<A HREF . . . > tags, which are hyperlinks to other web pages

<FRAMESET . . . > tags, which define sub-pages to a frame page

<FORM . . . > tags, which define an action when a form is submitted

Once links are identified in a document, the links are added to a queue which includes links yet to be analyzed. The analysis of the links in the queue is performed by the logic loop shown in FIG. 5B.

As illustrated, a list of links that are identified in documents are stored in a queue.

Links are evaluated with regard to whether they have already been processed. If the link is to a document that has already been processed, the link is discarded and another link is taken from the queue to be analyzed.

Links are also evaluated with regard to whether the link is an in-domain or out-of-domain link. A link that is an in-domain link is processed further. A link that is an out-of-domain link is discarded and another link is taken from the queue to be analyzed.

A link that is an in-domain link that has not already been processed is then evaluated with regard to whether the link is to a continuation document. Identifying a link as being a link to a continuation page is achieved by identifying whether any continuation document terms are associated with the link. As noted previously in FIG. 5A, the program is initialized to include continuation document terms. These are terms which, when associated with a particular link, serve to identify that link as being a link to a continuation document. As used herein, a term is “associated with a particular link” if it is to be displayed in proximity with the link such that a person or computer executable logic reviewing the document can make the inference that the link is to a continuation document in view of the proximity between the link and the continuation document terms.

If a link is determined to be a continuation document, the document is crawled (i.e., analyzed according to FIG. 5A) where the depth of counter for that document is not changed. Specifically, the following parameters are assigned to the child document prior to that child document being crawled as in FIG. 5A:

Web address=the web address of the link

Depth=current depth

Document type=continuation document link

Parent web address=current web address

This reflects the program treating a continuation document as being at the same depth as the document which links to the continuation document.

As also illustrated, if the link is determined not to be a continuation document, i.e., the link is a standard link, the document is crawled (i.e., analyzed according to FIG. 5A) Specifically, the following parameters are assigned to the child document prior to that child document being crawled as in FIG. 5A:

Web address=the web address of the link

Depth=current depth−1

Document type=child link

Parent web address=current web address

As is seen, the depth of counter for that document is reduced by 1. This reflects the program treating the document as being a child of the document to which that document is linked. As a result, the child is at a lower depth than the parent linking document.

The program operates recursively such that the logic operations illustrated in FIG. 5A are performed until no more documents remain to be analyzed and all of the links that are added to the queue in FIG. 5A are analyzed according to the logic operations illustrated in Figure SB.

As a result of crawling a web site, the following types of information may be identified: (a) the number of different documents found; (b) the web address of each document found; (c) the type of each document found (e.g., a root document, a frame, a child (i.e., a document at a lower level), or continuation document); (d) the logical level of each document found in the web site's hierarchy; and (e) the parent web address of each document found.

### EXAMPLES

1. Document Crawling Algorithm

The following example provides an example of computer executable code, in C++ language, for storing a web document, finding links contained in the document, and following the links that are in the same domain with discernment of standard links as opposed to lateral links. As discussed above, this routine is performed recursively.

void CCrawl::CrawlPage(CString sURL, int nType, int nDepth, CString sParentURL)
{

//****************
//* Initialize *
//****************
CString sPage, sPageUpper, sPageSave;
CString sTemp, sTempUpper;
CString sLink, sOriginalLink, sType;
int nPos1, nPos2;
CString sFilespec;
CString sLinkDesc;
CString sHeader;
bool bLinkOK = false;
CString sLinkServer;
StoreLink(sParentURL, sURL, nType, nDepth);
//*******************
//* Retrieve Page *
//*******************
//retrieve the base URL
if (!GetWebPage(sURL, sPage))
{

nCrawlErrors++;
return;

| } // end if | |
|---|---|
| nCrawlPages++; | |
| StorePage(sTemp); | |
| sPageSave = sPage; | |
| sPageUpper = sPage; | |
| sPageUpper.MakeUpper(); | |
| //**************** | |
| //* Find Links * | |
| //**************** | |
| //scan page for links | |
| //the loop for <A HREF=“src”> links | |
| nPos1 = sPageUpper.Find(“<A”); | |
| while (nPos1!=−1) | /* found <A */ |
| { | |

| sPageUpper = sPageUpper.Mid(nPos1+2); | |
|---|---|
| sPage = sPage.Mid(nPos1+2); | |
| nPos2 = sPageUpper.Find(“>”); | |
| if(nPos2!=−1) | /* found> */ |
| { | |

| sTemp = sPage.Left(nPos2); | |
|---|---|
| sTempUpper = sPageUpper.Left(nPos2); | |
| nPos2 = sPageUpper.Find(“</A>”); | |
| if(nPos2==−1) sLinkDesc = sTemp; else sLinkDesc = sPage.Left(nPos2); | |
| nPos2 = sTempUpper.Find(“HREF”); | |
| if(nPos2!=−1) | /* found HREF */ |
| { | |

| sTemp = sTemp.Mid(nPos2+4); | |
|---|---|
| sTempUpper = sTempUpper.Mid(nPos2+4); | |
| sTemp.TrimLeft(); | |
| sTempUpper.TrimLeft(); | |
| if(sTemp.Left(1)==“=”) | /* found = */ |
| { | |

sLink.Empty();
sTemp = sTemp.Mid(1);
sTempUpper = sTempUpper.Mid(1);
if(sTemp.Left(1)==“\”“) /* found opening ” */
{

sTemp = sTemp.Mid(1);
sTempUpper = sTempUpper.Mid(1);
nPos2 = sTemp.Find(“\”“);/* found closing ” */
if (nPos2!=−1)
{

sLink = sTemp.Left(nPos2); /* have link */

}

}
else
{

//If no “ was found, assume the rest of the text in the tag is the URL
sLink = sTemp;

}
if (!sLink.IsEmpty())
{

sLink = sTemp.Left(nPos2); /* have link */
sOriginalLink = sLink;
if (NormalizeLink(sLink, sURL /* base */, sFilespec, sType,

sLinkServer))/* http/https/ftp link */

{

if(sLinkServer.Find(sCrawlDomain)!=−1)

bLinkOK = true;

else

bLinkOK = false;

if(bLinkOK)
{

if (!IsKnownLink(sLink)) /* new link */
{

if(sTyper==“” || sType==“htm” || sType==“html” ||

sType==“asp” || sType==“nql” || sType==“dll” /* probable HTML page */ ||

sLink.Find(“?”)!=−1 /* CGI */ || sType==“nsf” /* Lotus

Notes */ || sType==“shtml”)

{

if(nDepth>1) /* more levels to crawl */
{

sPreviousLinks += sLink + “\n”;
//we have a link to crawl
if (ContainsContinuationText(sLinkDesc))
{

CrawlPage(sLink, LINK_CONTINUATION,

nDepth, sURL);

} // end if
else
{

CrawlPage(sLink, LINK_CHILD, nDepth−1, sURL);

} // end else

} // end if
else
{

//not crawling, max depth reached

} // end else

} // end if
else
{

//not crawlable type

} // end else

} // end if not-previously-seen-link
else
{

//link previously processed

} // end else

} // end if in-same-domain
else
{

//skipping, not in domain

} // end else

} // end if valid-link
else
{

//skipping, not a target protocol

} //end else

} // end if

} // end if

} // end if

} // end if
nPos1 = sPageUpper.Find(“<A”);

} // end while
sPage = sPageSave;
sPageUpper = sPage;
sPageUpper.MakeUpper();
//the loop for <FRAME... SRC=“url”... > links
nPos1 = sPageUpper.Find(“<FRAME ”);

| | |
|---|---|
| while (nPos1!=−1) | /* found <FRAME */ |
| { | |

| sPageUpper = sPageUpper.Mid(nPos1+6); | |
|---|---|
| sPage = sPage.Mid(nPos1+6); | |
| nPos2 = sPageUpper.Find(“>”); | |
| if(nPos2!=−1) | /* found> */ |
| { | |

| sTemp = sPage.Left(nPos2); | |
|---|---|
| sTempUpper = sPageUpper.Left(nPos2); | |
| nPos2 = sPageUpper.Find(“</FRAME>”); | |
| if(nPos2==−1) sLinkDesc = sTemp; else sLinkDesc = sPage.Left(nPos2); | |
| nPos2 = sTempUpper.Find(“SRC”); | |
| if(nPos2!=−1) | /* found SRC */ |
| { | |

| sTemp = sTemp.Mid(nPos2+3); | |
|---|---|
| sTempUpper = sTempUpper.Mid(nPos2+3); | |
| sTemp.TrimLeft(); | |
| sTempUpper.TrimLef(); | |
| if(sTemp.Left(1)==“=”) | /* found = */ |
| { | |

| | |
|---|---|
| sLink.Empty(); | //[121] |

sTemp = sTemp.Mid(1);
sTempUpper = sTempUpper.Mid(1);
if(sTemp.Left(1)==“\”“) /* found opening ”*/

{

sTemp = sTemp.Mid(1);
sTempUpper = sTempUpper.Mid(1);
nPos2 = sTemp.Find(“\”“);/* found closing ” */
if(nPos2!=−1)
{

sLink = sTemp.Left(nPos2); /* have link */

}

}
else
{

//[121] If no “ was found, assume the rest of the text in the tag is the

URL

sLink = sTemp;

}
if (!sLink.IsEmpty()) //[121]
{

sOriginalLink = sLink;
//sCrawlLog += “ Found raw link: ” + sLink + “\r\n”;// debug
if (NormalizeLink(sLink, sURL /* base */, sFilespec, sType,

sLinkServer))/* http/https/ftp link */

{

if(sLinkServer.Find(sCrawlDomain)!=−1)

bLinkOK = true;

else

bLinkOK = false;

if(bLinkOK) //...[121]
{

//if (sPreviousLinks.Find(sLink+“\n”)==−1) /* new link */
if (!IsKnownLink(sLink)) /* new link */
{

if(sType==“” || sType==“htm” || sType==“html” ||

sType==“asp” || sType==“nql” || sType==“dll” /* probable HTML page */ ||

sLink.Find(“?”)!=−1 /* CGI */ || sType==“nsf” /* Lotus

Notes */)

{

if(nDepth>1) /* more levels to crawl */
{

sPreviousLinks += sLink + “\n”;
//we have a frame page to crawl
sCrawlLog += “ Following frame page ” +

sOriginalLink + “\r\n”;

CrawlPage(sLink, LINK_FRAME, nDepth−1, sURL);
sCrawlLog += “Continuing scan of” + sURL + “\r\n”;

} // end if
else
{

//sCrawlLog += “ not crawling, max depth

reached\r\n”;

} //end else

} // end if
else
{

//sCrawlLog += “ not crawlable type\r\n”;

} // end else

} // end if not-previously-seen-link
else
{

//sCrawlLog += “ link previously processed\r\n”;

} // end else

} // end if in-same-domain
else
{

//sCrawlLog +=“ skipping, not in domain\r\n”; // debug

} // end else

} // end if valid-link
else
{

//sCrawlLog += “ skipping, not a target protocol\r\n”;

} // end else

} // end if

} // end if

} // end if

} // end if
nPos1 = sPageUpper.Find(“<FRAME ”);

} // end while

}

2. Document Crawling Algorithm

The following is an example of computer executable code, in C++ language, from an external application, which shows how the entire site crawling algorithm is called from another program. This particular application crawls a site, then displays a site map based on the results of the site crawl.

void CLateralCrawlDig::OnSiteMap()
{

CCrawl crawl;
CString sMsg, sLine;

CWaitCursor wc;
UpdateData(true);
if (m_term!=“”) crawl.AddContinuationTerm(m_term);
int nCrawlDepth = atoi(m_depth);
if (!crawl.CrawlSite(m_url, nCrawlDepth))
{

MessageBox(“The site crawl failed.\r\n\r\nThe URL may be invalid or

inaccessible.”, “Site Crawl Faile”, MB_ICONEXCLAMATION);

return;

} // end if
CStdioFile fileCrawlLog;
fileCrawlLog.Open(“CrawlLog.txt”, CFile::modeCreate|CFile::modeWrite);
sLine.Format(“Crawl Log\n\nCrawling %s to %d levels\n\n”,

m_url, nCrawlDepth);

fileCrawlLog.WriteString(sLine);
for (int p=0; p<crawl.nPages; p++)
{

int nDepth = crawl.nLinkDepth.GetAt(p);
CString sType;
switch(crawl.nLinkType.GetAt(p))
{
case LINK_ROOT:

sType = “root”;
break;

case LINK_FRAME:

sType = “frame”;
break;

case LINK_CONTINUATION:

sType = “continuation”;
break;

case LINK_CHILD:

sType = “child”;
break;

} // end switch
for (int i=0; i<nDepth; i++)

fileCrawlLog.WriteString(“\t”);

sLine.Format(“Link %s, Level %d, Type %s, Parent %s\n”,

crawl.sLinkURL.GetAt(p),
nDepth,
sType,
crawl.sLinkParentURL.GetAt(p));
fileCrawlLog.WriteString(sLine);

} // end for p
fileCrawlLog.Close();
AfxMessageBox(“The site crawl is complete.\r\n\r\nCrawlLog.txt contains a site

crawl log”);

UpdateData(false);

}

3. Complete Crawling Algorithm

The following example provides an example of computer executable code, in C++ language, for crawling a document and links to that document to a specified depth where there is sensitivity in the crawling for the [existence] of continuation documents. If a continuation document is detected, that document is treated as though it is at the same level in the site's hierarchy as the referencing document.

[image]

[image]

[image]

[image]

[image]

[image]

[image]

[image]

[image]

[image]

[image]

[image]

[image]

[image]

[image]

[image]

While the present invention is disclosed by reference to the various embodiments and examples detailed above, it should be understood that these examples are intended in an illustrative rather than limiting sense, as it is contemplated that modifications will readily occur to those skilled in the art which are intended to fall within the scope of the present invention.

What is claimed is:

1. A method for identifying continuation documents within an Internet domain, the method comprising:
taking a first document address and continuation document terms;
having computer executable logic retrieve a first document identified by the first document address;
having computer executable logic identify any links to other documents in the first document; and
having the computer system identify which of the identified links to the other documents are lateral links to continuation documents of the first document by identifying whether any continuation document terms are associated with the links.

2. A method according to claim 1, the method further comprising:
modifying a crawl depth for a document identified by an identified link which is not a continuation document, the crawl depth not being modified for a document identified by an identified link which is a continuation document.

3. A method according to claim 1, the method further comprising:
having the computer executable logic determine which of the identified links do not specify the same Internet domain as the first document address.

4. A method according to claim 3, the method further comprising:
having the computer executable logic determine which of the identified links have been previously processed.

5. A method according to claim 3, the method further comprising:
modifying a crawl depth for a document identified by an identified link which is not a continuation document, the crawl depth not being modified for a document identified by an identified link which is a continuation document.

6. A method according to claim 1, the method further comprising:
having computer executable logic determine which of the identified links have been previously processed.

7. A system for identifying continuation documents within an Internet domain, the system comprising:
computer readable logic which takes a first document address and continuation document terms;
computer readable logic which retrieves a first document identified by the first document address;
computer readable logic which identifies any links to other documents in the first document; and
computer readable logic which identifies which of the identified links to the other documents are lateral links to continuation documents of the first document by identifying whether any continuation document terms are associated with the links.

8. A system according to claim 7, the system further comprising:
computer readable logic which modifies a crawl depth for a document identified by an identified link which is not a continuation document, the crawl depth not being modified for a document identified by an identified link which is a continuation document.

9. A system according to claim 7, the system further comprising:
computer readable logic which determines which of the identified links do not specify the same internet domain as the first document address.

10. A system according to claim 9, the system further comprising:
computer executable logic which determines which of the identified links have been previously processed.

11. A system according to claim 9, the system further comprising:
computer readable logic which modifies a crawl depth for a document identified by an identified link which is not a continuation document, the crawl depth not being modified for a document identified by an identified link which is a continuation document.

12. A system according to claim 7, the system further comprising:
computer readable logic which determines which of the identified links have been previously processed.

13. A method for crawling documents within an Internet domain, the method comprising:
taking a first document address, a crawl depth and continuation document terms;
having computer executable logic retrieve a first document identified by the first document address;
having computer executable logic identify any links in the first document; and
having computer executable logic identify which of the identified links in the first document are
out-of domain links because the identified links do not specify the same Internet domain as the first document address;
lateral links to continuation documents of the first document by identifying that there are continuation document terms associated with the links, and
standard links to documents lower in the Internet domain's hierarchy by identifying that there are no continuation document terms associated with the links.

14. A method according to claim 13, further comprising
having computer executable logic modify the crawl depth associated with documents that are identified as having a standard link to the first document.

15. A method according to claim 13, the method further comprising:
having computer executable logic discard any identified links that have already been analyzed.

16. A method according to claim 13, further comprising
having computer executable logic modify the crawl depth associated with documents that are identified as having a standard link to the first document, the crawl depth associated with documents that are identified as having a lateral link to the first document not being modified.

17. A system for crawling documents within an Internet domain, the system comprising:
computer readable logic which takes a first document address, a crawl depth and continuation document terms;
computer readable logic which retrieves a first document identified by the first document address;
computer readable logic which identifies any links in the first document; and
computer readable logic which identifies which of the identified links in the first document are
out-of domain links because the identified links do not specify the same Internet domain as the first document address;
lateral links to continuation documents of the first document by identifying that there are continuation document terms associated with the links, and
standard links to documents lower in the Internet domain's hierarchy by identifying that there are no continuation document terms associated with the links.

18. A system according to claim 18, further comprising
computer readable logic which modifies the crawl depth associated with documents that are identified as having a standard link to the first document.

19. A system according to claim 18, the system further comprising:
computer readable logic which discards any identified links that have already been analyzed.

20. A system according to claim 18, further comprising
computer readable logic which modifies the crawl depth associated with documents that are identified as having a standard link to the first document, the crawl depth associated with documents that are identified as having a lateral link to the first document not being modified.

21. A method for crawling documents within an Internet domain, the method comprising:
(a) having computer executable logic retrieve a document identified by a document address and a crawl depth;
(b) having computer executable logic identify any links in the document;
(c) having computer system identify which of the identified links in the document are
out-of domain links because the identified links do not specify the same Internet domain as the document address,
lateral links to continuation documents of the document by identifying that there are continuation document terms associated with the links, and
standard links to documents lower in the Internet domain's hierarchy by identifying that there are no continuation document terms associated with the links;
(d) performing steps (a)-(c) for documents that are identified as being laterally linked to the document of step (a), where the same crawl depth is employed for the laterally linked documents as the crawl depth for the document of step (a); and
(e) decreasing the crawl depth by 1 for documents that are identified as being standardly linked to the document of step (a) and performing steps (b)-(d) for the standardly linked documents if the resulting decreased crawl depth is greater than 1.

22. A method according to claim 22, the method further comprising:
having computer executable logic discard any identified links that have already been analyzed prior to performing steps (d) and (e).

23. A system for crawling documents within an Internet domain, the system comprising:
computer readable logic which
(a) retrieves a document identified by a document address and a crawl depth;
(b) identifies any links in the document;
(c) identifies which of the identified links in the document are
out-of domain links because the identified links do not specify the same Internet domain as the document address,
lateral links to continuation documents of the document by identifying that there are continuation document terms associated with the links, and
standard links to documents lower in the Internet domain's hierarchy by identifying that there are no continuation document terms associated with the links;
(d) performs steps (a)-(c) for documents that are identified as being laterally linked to the document of step (a), where the same crawl depth is employed for the laterally linked documents as the crawl depth for the document of step (a); and
(e) decreases the crawl depth by 1 for documents that are identified as being standardly linked to the document of step (a) and performing steps (b)-(d) for the standardly linked documents if the resulting decreased crawl depth is greater than 1.
